(19) United States
(12) Patent Application Publication
(10) Pub. No.: US 2025/0238220 A1
(43) Pub. Date: Jul. 24, 2025

(54) SERVERLESS DEPLOYMENTS USING MACHINE LEARNING

(71) Applicant: Dell Products L.P., Round Rock, TX (US)

(72) Inventors: Bijan Kumar Mohanty, Austin, TX (US); David J. Linsey, Marietta, GA (US); Hung Dinh, Austin, TX (US)

(21) Appl. No.: 18/421,448

(22) Filed: Jan. 24, 2024

(51) Int. Cl. G06F 8/65

(52) U.S. Cl. CPC G06F 8/65

(57) ABSTRACT

A method comprises receiving a request for cloud deployment of at least one function, wherein the request includes one or more features of the at least one function. The one or more features are analyzed using one or more machine learning algorithms. The method further comprises selecting, based at least in part on the analyzing, a cloud platform of a plurality of cloud platforms to deploy the at least one function, and interfacing with the cloud platform to enable deployment of the at least one function.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to cloud provider deployments in information processing systems.

### BACKGROUND

Multiple deployment options including, for example, containers and cloud-native applications, are available to software developers. A serverless model is a cloud-native development model that allows developers to build and run applications without having to manage servers. In a serverless model, a cloud provider provisions and maintains a server infrastructure for code that has been packaged (e.g., in containers) by developers for deployment. However, due to numerous differences between cloud offerings, developers or other technical personnel experience difficulties with selection of cloud providers for serverless models. In some cases, a given cloud provider may not satisfy all of the requirements for application implementation, and due to a lack of standardization between cloud provider platform configurations, switching to or adding additional cloud providers may be problematic.

### SUMMARY

Embodiments provide a cloud deployment platform in an information processing system.

For example, in one embodiment, a method comprises receiving a request for cloud deployment of at least one function, wherein the request includes one or more features of the at least one function. The one or more features are analyzed using one or more machine learning algorithms. The method further comprises selecting, based at least in part on the analyzing, a cloud platform of a plurality of cloud platforms to deploy the at least one function, and interfacing with the cloud platform to enable deployment of the at least one function.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a cloud deployment platform according to an illustrative embodiment.

FIG. 2 depicts an operational flow for cloud deployment of serverless functions according to an illustrative embodiment.

FIG. 3 depicts example pseudocode for generation of a hash digest of files corresponding to a cloud deployment of a serverless function according to an illustrative embodiment.

FIG. 4 depicts sample training data for training a machine learning algorithm to predict a cloud provider for a serverless function according to an illustrative embodiment.

FIG. 5 depicts an architecture of a neural network used for multi-class classification according to an illustrative embodiment.

FIG. 6A depicts example pseudocode for importation of libraries according to an illustrative embodiment.

FIG. 6B depicts example pseudocode for loading historical serverless runtime data into a data frame according to an illustrative embodiment.

FIG. 7 depicts example pseudocode for encoding a dataset for machine learning according to an illustrative embodiment.

FIG. 8 depicts example pseudocode for normalizing and reducing dimensionality of a dataset according to an illustrative embodiment.

FIG. 9 depicts example pseudocode for splitting a dataset into training and testing components and for creating separate datasets for independent and dependent variables according to an illustrative embodiment.

FIG. 10 depicts example pseudocode for building a neural network according to an illustrative embodiment.

FIG. 11 depicts example pseudocode for training and computing loss of a neural network model according to an illustrative embodiment.

FIG. 12 depicts a plurality of decision trees used in connection with a random forest classifier according to an illustrative embodiment.

FIG. 13 depicts example pseudocode for importation of libraries according to an illustrative embodiment.

FIG. 14 depicts example pseudocode for splitting a dataset into training and testing components and for creating separate datasets for independent and dependent variables according to an illustrative embodiment.

FIG. 15 depicts example pseudocode for training and computing accuracy of a random forest classifier according to an illustrative embodiment.

FIG. 16 depicts an operational diagram corresponding to operation of the cloud interfacing and monitoring engine according to an illustrative embodiment.

FIGS. 17A and 17B depict example pseudocode for deploying a serverless function in a first cloud provider platform according to an illustrative embodiment.

FIG. 18 depicts example pseudocode for deploying a serverless function in a second cloud provider platform according to an illustrative embodiment.

FIGS. 19A and 19B depict example pseudocode for retrieving serverless function metrics from a first cloud provider platform according to an illustrative embodiment.

FIGS. 20A and 20B depict example pseudocode for retrieving serverless function metrics from a second cloud provider platform according to an illustrative embodiment.

FIG. 21 depicts a process for cloud deployment of serverless functions according to an illustrative embodiment.

FIGS. 22 and 23 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a requesting device receives messages without any significant time delay. Of course, it should be understood that depending on the particular temporal nature of the system in which an embodiment is implemented, other appropriate timescales that provide at least contemporaneous performance and output can be achieved.

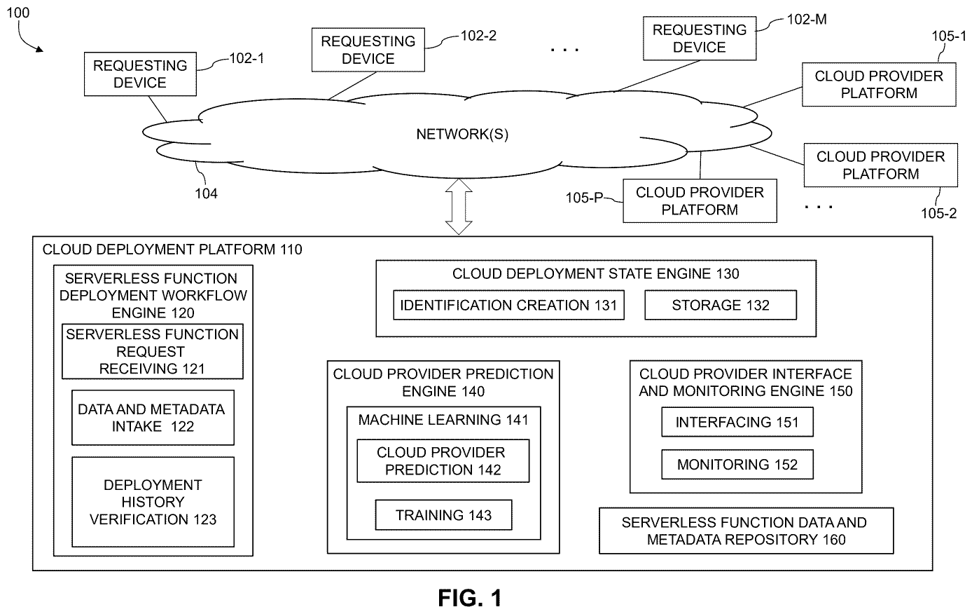

FIG. 1 shows an information processing system 100 configured in accordance with an illustrative embodiment. The information processing system 100 comprises requesting devices 102-1, 102-2, . . . 102-M (collectively “requesting devices 102”) and cloud provider platforms 105-1, 105-2, . . . 105-P (collectively “cloud provider platforms 105”). The requesting devices 102 and cloud provider platforms 105 communicate over a network 104 with a cloud deployment platform 110. The variable M and other similar index variables herein such as K, L, S and P are assumed to be arbitrary positive integers greater than or equal to one.

The requesting devices 102 and one or more devices of the cloud provider platforms 105 can comprise, for example, Internet of Things (IoT) devices, server, desktop, laptop or tablet computers, mobile telephones, or other types of processing devices capable of communicating with the cloud deployment platform 110 over the network 104. Such devices are examples of what are more generally referred to herein as “processing devices.” Some of these processing devices are also generally referred to herein as “computers.” The requesting devices 102 and one or more devices of the cloud provider platforms 105 may also or alternately comprise virtualized computing resources, such as virtual machines (VMs), containers, etc. The requesting devices 102 and/or one or more devices of the cloud provider platforms 105 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Cloud deployment services may be provided for users utilizing one or more machine learning models, although it is to be appreciated that other types of infrastructure arrangements could be used. At least a portion of the available services and functionalities provided by the cloud deployment platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the cloud deployment platform 110, as well as to support communication between the cloud deployment platform 110 and connected devices (e.g., requesting devices 102 and one or more devices of the cloud provider platforms 105) and/or other related systems and devices not explicitly shown.

In some embodiments, the requesting devices 102 are assumed to be associated with repair technicians, system administrators, information technology (IT) managers, software developers, release management personnel or other authorized personnel configured to access and utilize the cloud deployment platform 110. The requesting devices 102 can also be respectively associated with one or more customers requiring the services of one or more cloud providers. Some non-limiting examples of cloud providers that may correspond to the cloud provider platforms 105 include, but are not necessarily limited to, Amazon® Web Services (AWS®), Azure®, Google® Cloud Platform (GCP®) and/or Oracle® cloud providers.

As noted hereinabove, due to numerous differences between cloud offerings, developers or other technical personnel experience difficulties with selection of cloud providers for serverless models. For example, a given cloud provider may not satisfy all of the requirements for application and/or function implementation, and due to a lack of standardization between cloud provider platform configurations, switching to or adding additional cloud providers may be problematic.

In order to address the problems with current approaches, illustrative embodiments provide technical solutions which use machine learning to intelligently recommend optimum cloud providers for different functions. For example, depending on the functions being performed by an application, the application may require different types of cloud providers. The embodiments advantageously provide a cloud deployment framework that permits intelligent selection of cloud providers based on a variety of features associated with serverless functions. As an additional advantage, the embodiments provide a cloud deployment framework which monitors the implementation of functions by a cloud provider and continually reassesses the best fit cloud provider and hosting features. Based on the results of monitoring, the framework is configured to dynamically replace and/or add different cloud providers to deploy serverless functions as the requirements associated with the functions change and/or evolve. Leveraging machine learning, the framework predicts optimal cloud providers for serverless functions based on historical data and metadata corresponding to multiple features of the functions.

The cloud deployment platform 110 in the present embodiment is assumed to be accessible to the requesting devices 102 and/or cloud provider platforms 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the cloud deployment platform 110 includes a serverless function deployment workflow engine 120, a cloud deployment state engine 130, a cloud provider prediction engine 140, a cloud provider interface and monitoring engine 150 and a serverless function data and metadata repository 160. The serverless function deployment workflow engine 120 includes a serverless function request receiving layer 121, a data and metadata intake layer 122 and a deployment history verification layer 123. The cloud deployment state engine 130 includes an identification creation layer 131 and a storage layer 132. The cloud provider prediction engine 140 includes a machine learning layer 141 comprising cloud provider prediction and training layers 142 and 143. The cloud provider interface and monitoring engine 150 includes an interfacing layer 151 and a monitoring layer 152.

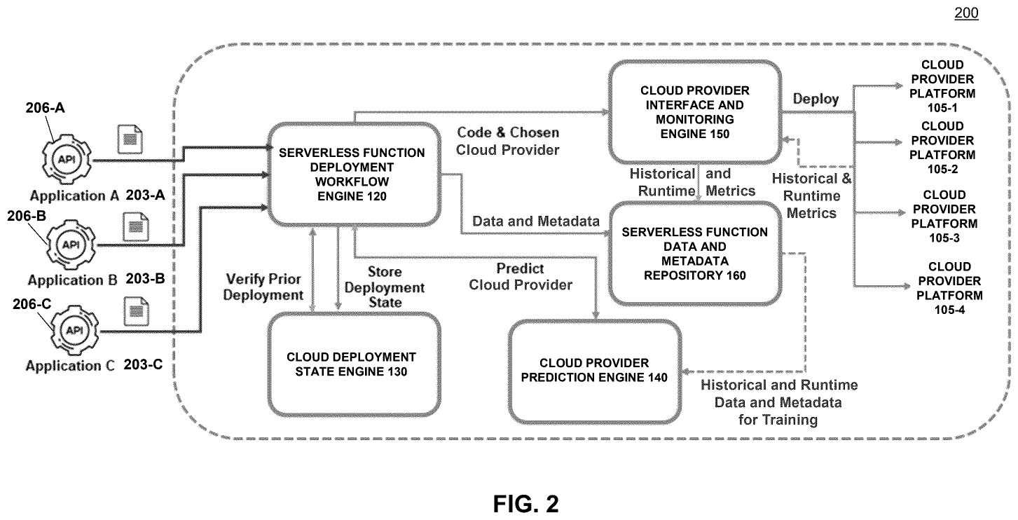

The serverless function request receiving layer 121 of the serverless function deployment workflow engine 120 receives serverless function requests from one or more requesting devices 102. Referring to the operational flow 200 of FIG. 2, in a non-limiting illustrative embodiment, the serverless function deployment workflow engine 120 (e.g., serverless function request receiving layer 121) receives requests from applications running on the requesting devices 102. For example, the serverless function requests may be initiated from application A 203-A, application B 203-B and application C 203-C (collectively “applications 203”) and comprise application programming interface (API) calls using one or more APIs (e.g., API 206-A, API 206-B and API 206-C (collectively “APIs 206”). In some embodiments, the requests may be automated or initiated by one or more users of the requesting devices 102. As explained in more detail herein, the serverless function deployment workflow engine 120 identifies cloud providers for functions by invoking a request to the cloud provider prediction engine 140 to predict a cloud provider for a given function. The cloud provider prediction engine 140 leverages machine learning to predict an optimal cloud provider for the given function.

The data and metadata intake layer 122 collects and processes data and metadata received in a request for cloud deployment of a serverless function. The data and metadata for a function to be deployed may be included with a serverless function request from one or more requesting devices 102, and can be collected from, for example, the serverless function request receiving layer 121. The data and metadata for a function to be deployed is sent to and stored in the serverless function data and metadata repository 160. The data and metadata for a function to be deployed comprise, for example, one or more features identifying at least one of a size of code for the function, a language of the code for the function, a complexity tier of the function, an interactivity determination of the function (yes or no depending on if the function is intended to be used in an interactive manner), a cold start time of the function, an execution time of the function, a memory consumption of the function and a cost of the function (e.g., deployment cost, storage cost, network overhead, etc.). In illustrative embodiments, a complexity tier of a function is based on cyclomatic, dependency and/or integration complexity as returned by code coverage tools such as, for example, SonarQube®, etc. Cold start time and execution time may be, for example, average or median times. One or more of the features can be in the form of data in addition to or as an alternative metadata.

Referring to FIGS. 1 and 2, in connection with the cloud deployment state engine 130, the deployment history verification layer 123 of the serverless function deployment workflow engine 120 verifies a deployment history of a function that is the subject of a request for deployment. In illustrative embodiments, the verification comprises determining whether a given function was previously deployed on a cloud platform, and if the given function was previously deployed on a cloud platform, determining whether code for the function specified in a request is unchanged from the previous deployment. In more detail, in an illustrative embodiment, the deployment history verification layer 123 verifies the previous deployment history of a serverless function by invoking a call to the cloud deployment state engine 130. If the serverless function was deployed in the past on a cloud provider platform 105 and no changes to the function code were made since the previous deployment, the call to the cloud deployment state engine 130 is returned as true, and the serverless function deployment workflow engine 120 will not continue with the deployment.

If a response from the cloud deployment state engine 130 indicates that a given function was not previously deployed, the serverless function deployment workflow engine 120 invokes a request to the cloud provider prediction engine 140, which leverages machine learning to predict an optimized cloud provider platform 105 to deploy the serverless function. The serverless function deployment workflow engine 120 sends the serverless function code and data identifying the predicted cloud provider platform 105 to the cloud provider interface and monitoring engine 150, which is configured to interface with the predicted cloud provider platform 105 to cause deployment of the function by the predicted cloud provider platform 105.

The cloud deployment state engine 130 maintains data corresponding to deployment states of serverless functions by respective cloud provider platforms 105. This data management helps prevent duplicate deployments if multiple deployment requests for the same function are received. The identification creation layer 131 of the cloud deployment state engine 130 generates a unique identifier for the deployment of a given function. In illustrative embodiments, the generating of the unique identifier comprises using a hash function to generate a hash digest of one or more files corresponding to the deployment of the function. The generated hash digest is stored in a storage layer 132 of the cloud deployment state engine 130. In illustrative embodiments, the storage layer 132 comprises a persistent cache, but the embodiments are not necessarily limited thereto. Upon receiving a request to verify a past deployment of a function, the cloud deployment state engine 130 searches the storage layer 132 with a function identifier (e.g., hash value) and returns a result based on whether a previous deployment (e.g., hash digest) is found.

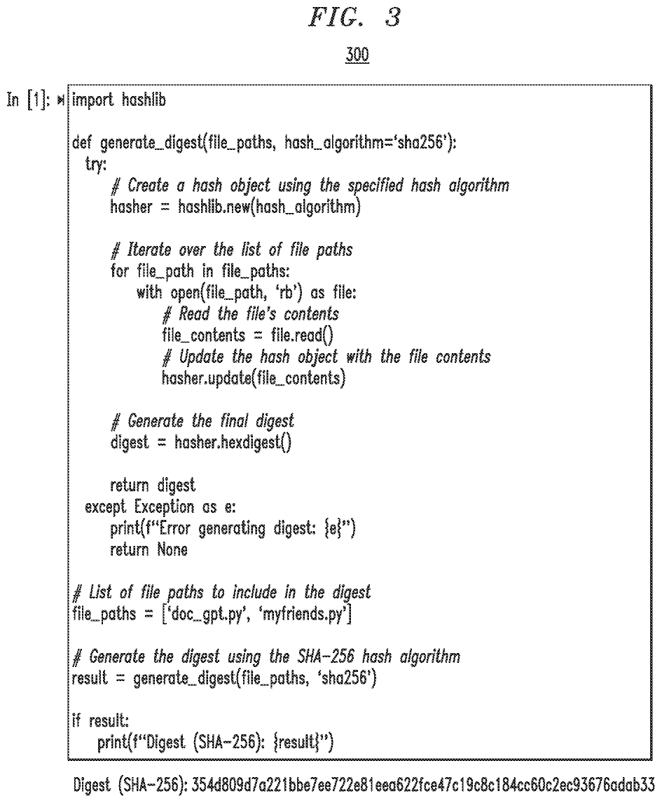

In some embodiments, the hash digest is created using an SHA-256 algorithm, which can be available in a Python library. In the case of multiple files as part of a package of deployments, a zip file or a Java archive (JAR) file can be created and passed to a hashlib library for creating the digest. FIG. 3 depicts example pseudocode 300 for generation of a hash digest of files corresponding to a cloud deployment of a serverless function. The pseudocode 300 includes Python code for creating a hash of multiple files.

When a serverless function with a code package is deployed by a cloud provider platform 105, the unique hash digest along with results of the deployment (e.g., non-error and error situations) is cached in the storage layer 132 for the future searches and reference. Additional metadata including the deployment cloud provider platform (e.g., AWS® platform, Azure® platform, GCP® platform, etc.) and time taken for the deployment are captured for analytics and additional training of the machine learning algorithms used by the cloud provider prediction engine 140 for future predictions. The additional metadata can also be cached in the storage layer 132.

The cloud provider interface and monitoring engine 150 collects historical deployment and runtime data and metadata for serverless functions from the cloud provider platforms 105. The collected deployment and runtime data and metadata is sent to and stored in the serverless function data and metadata repository 160. The historical deployment and runtime data and metadata comprises, for example, respective ones of a plurality of functions associated with at least one of: (i) a code size; (ii) a code language; (iii) a complexity tier; (iv) an interactivity determination; (v) a cold start time (e.g., average, median, etc.); (vi) an execution time (e.g., average, median, etc.); (vii) a memory consumption; and (viii) a cost (e.g., deployment cost, storage cost, network overhead, etc.). One or more of the features can be in the form of data in addition to or as an alternative metadata.

As explained in more detail herein, historical deployment data and metadata from the serverless function data and metadata repository 160 is used by the cloud provider prediction engine 140 to train one or more machine learning models to accurately predict a cloud provider for a newly received request for deployment of a serverless function on a cloud provider platform 105. In some embodiments, historical deployment data and metadata is used as a first training dataset, and following deployment, runtime metrics data and metadata is used as a second (subsequent) training dataset to fine-tune the one or more machine learning algorithms that have been trained with the first training dataset.

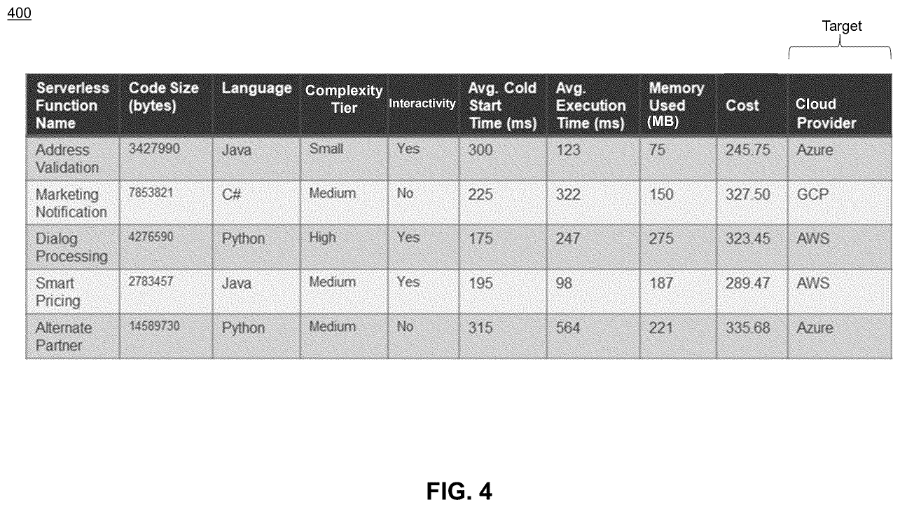

FIG. 4 depicts a table 400 of sample historical deployment data and metadata and/or runtime metrics data and metadata that may be used to train the one or more machine learning models used for cloud provider prediction by the cloud provider prediction engine 140. It is to be understood that the data illustrated in table 400 is illustrative, and the embodiments are not necessarily limited to what is shown in FIG. 4. Historical deployment data and metadata and/or runtime metrics data and metadata with more or less features may be used in other embodiments. As can be seen in the table 400, the training data identifies multi-dimensional features. The features include, for example, a serverless function name, a code size (e.g., in bytes), a code language (e.g., JAVA, C#, Python), a complexity tier (e.g., small, medium, high), an interactivity determination (yes/no), an average a cold start time (e.g., in milliseconds), an average execution time (e.g., in milliseconds), a memory consumption (e.g., in megabytes), and a cost (e.g., deployment cost, storage cost, network overhead, overall cost, etc.). The cloud providers are identified as targets in the table 400, as the target variable that is being predicted by the machine learning layer 141 of the cloud provider prediction engine 140 is a cloud provider.

The cloud provider prediction engine 140, more particularly, the training layer 143 of the machine learning layer 141 uses the historical deployment data and metadata and/or runtime metrics data and metadata collected by the cloud provider interface and monitoring engine 150 to train one or more machine learning algorithms used by the cloud provider prediction layer 142 to predict a cloud provider to deploy a given function.

The cloud provider prediction layer 142 of the cloud provider prediction engine 140 predicts, with a high degree of accuracy, a cloud provider to deploy a given function. The prediction is based, at least in part, on a variety of features used in the training data received from the serverless function data and metadata repository 160. Given the complexity and dimensionality of the variety of features, illustrative embodiments utilize a deep learning and/or a shallow learning approach. A determination of whether one or a combination of the approaches is used is based on a variety of criteria including number of features, complexity in the relationships between the features and the target value and the number of training datasets.

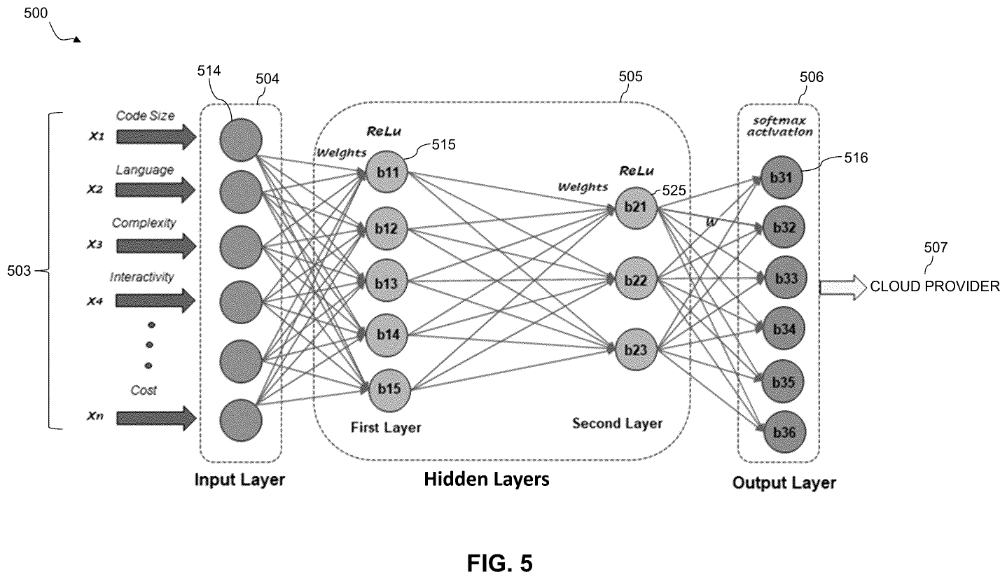

Referring, for example, to FIG. 5, a deep learning approach utilizes a deep neural network by building a dense, multi-layer neural network that functions as a sophisticated multi-class classifier. In this case, there are as many classes as there are cloud providers. As shown in FIG. 5, the neural network 500 comprises, for example, a deep neural network comprising an input layer 504, one or more hidden layers 505 and an output layer 506. Input layer 504 comprises a plurality of neurons 514 (nodes) that matches the number of input independent variables (e.g., features). Hidden layers 505 comprise first and second layers. The number of neurons 515 and 525 in each of the first and second layers depend on the number of neurons 514 in the input layer 504. As the machine learning model is a multi-class classification model, the output layer 506 includes the same number of neurons 516 as the number of cloud providers.

Although there are five neurons/nodes 515 shown in the first layer of the hidden layers 505 and three neurons/nodes 525 shown in the second layer of the hidden layers 505, the actual number of neurons 515 and 525 depend on the total number of neurons 514 in the input layer 504. For example, the number of neurons 515 in the first layer is calculated based on an algorithm matching the power of 2 to the number of input neurons 514. For example, in a non-limiting illustrative example, if the number of input variables is 19, the number of neurons in the first layer of the hidden layers 505 is 2⁵, which is equal to 32. 2⁴, which is equal to 16, is too small (e.g., less than 19). As a result, the first layer of the hidden layers 505 will have 2⁵=32 neurons, and the second layer of the hidden layers 505 will include 2⁴=16 neurons. If there were a third hidden layer, it would include 2³=8 neurons. The embodiments are not necessarily limited to basing the number of neurons 515 and 525 in the hidden layers 505 on the number of neurons 514 in the input layer 504, and other methods to determine the number of neurons 515 and 525 may be used.

According to illustrative embodiments, the neurons 515 and 525 in the hidden layers 505 and the neurons 516 in the output layer 506 utilize an activation function which determines whether the neuron will fire or not fire. For example, a rectified linear unit (ReLu) activation function is used for the neurons 515 and 525 in both the first and second ones of the hidden layers 505. The neurons 516 in the output layer utilize a Softmax activation function. The embodiments are not necessarily limited to the ReLu and Softmax activation functions.

In the illustrative embodiment of FIG. 5, each of the neurons 514 connects with each of the neurons 515, each of the neurons 515 connects with each of the neurons 525 and each of the neurons 525 connects with each of the neurons 516. Each connection has a weight factor and each of the neurons 515, 525 and 516 has a bias factor. In an illustrative embodiment, the weight and bias values may be randomly set by the neural network 500, and may start at values of 1 or 0. In illustrative embodiments, each neuron 515 computes a weighted sum (WS) by adding the products of each input variable (X1, X2, X3, X4, . . . , Xn) 503 (e.g., code size, code language, complexity, interactivity, cost) with their weight factors and then adding the bias of the neuron 515. The formula for this calculation is shown as equation (1) below.

$$WSz = ( X 1 ) ( W 1 z ) + ( X 2 ) ( W 2 z ) + ( X 3 ) ( W 3 z ) + ( X 4 ) ( W 4 z ) , \text{} … , ( X n ) ( Wnz ) + b 1 z \qquad ( 1 )$$

where WSz is the weighted sum of neuron Z, where Z is from 1 (for the 1^{st} neuron 515) to the number of neurons 515 in the first layer of the hidden layers 505. X1, X2, etc. are the input values to the model and W1z, W2z, etc. are the weight values applied to the connections to the neuron Z from the input neurons 514 and b1z is the bias value of neuron Z. This weighted sum WSz is input to an activation function (e.g., in this case ReLu) to compute the value of the activation function for each neuron 515. The weighted sum values of all neurons 515 in the first layer are calculated in accordance with equation (1).

In illustrative embodiments, each neuron 525 computes a next weighted sum (NWS) by adding the products of each weighted sum from the neurons 515 (WS1, WS2, WS3, WS4, . . . , WSz) with their weight factors and then adding the bias of the neuron 525. The formula for this calculation is shown as equation (2) below.

$$NWSy = ( WS 1 ) ( W 1 y ) + ( WS 2 ) ( W 2 y ) + ( WS 3 ) ( W 3 y ) + ( WS 4 ) ( W 4 y ) , \text{} … , ( WSz ) ( Wzy ) + b 2 y \qquad ( 2 )$$

where NWSy is the weighted sum of neuron Y, where Y is from 1 (for the 1^{st} neuron 525) to the number of neurons 525 in the second layer of the hidden layers 505. WS1, WS2, etc. are the weighted sums from the neurons 515 and W1y, W2y, etc. are the weight values applied to the connections to the neuron Y from the neurons 515 and b2y is the bias value of neuron Y. This next weighted sum NWSy is input to an activation function (e.g., in this case ReLu) to compute the value of the activation function for each neuron 525. The next weighted sum values of all neurons 525 in the second layer are calculated in accordance with equation (2).

In illustrative embodiments, each neuron 516 computes a final weighted sum (FWS) by adding the products of each next weighted sum from the neurons 525 (NWS1, NWS2, . . . , NWSy) with their weight factors and then adding the bias of the neuron 516. The formula for this calculation is shown as equation (3) below.

$$FWSp = ( NWS 1 ) ( W 1 p ) + ( NWS 2 ) ( W 2 p ) , … , ( NWSy ) ( Wyp ) + b 3 p \qquad ( 3 )$$

where FWSp is the weighted sum of neuron P, where P is from 1 (for the 1^{st} neuron 516) to the number of neurons 516 in the output layer 506. NWS1, NWS2, etc. are the next weighted sums from the neurons 525 and W1p, W2p, etc. are the weight values applied to the connections to the neuron P from the neurons 525 and b3p is the bias value of neuron P. This final weighted sum FWSp is input to an activation function (e.g., in this case Softmax) to compute the value of the activation function for each neuron 516. The final weighted sum values of all neurons 516 in the output layer 506 are calculated in accordance with equation (3).

The final weighted sum values are compared to target values. Depending upon the difference from the target values, loss values are calculated. The pass through of the neural network 500 is a forward propagation, which calculates error and drives a backpropagation through the neural network 500 to minimize the loss (e.g., error) at each neuron 514, 515, 525 and 516 of the neural network 500. Considering loss may be generated by all the neurons 514, 515, 525 and 516 in the neural network 500, a backpropagation process goes through each layer from the output layer 506 to the input layer 504 and attempts to minimize the loss by using a gradient descent-based optimization mechanism. Considering the neural network 500 is used in illustrative embodiments as a multi-class classifier, illustrative embodiments use a loss function as “categorical_crossentropy”, adam (adaptive moment estimation) as an optimization algorithm, and metrics values as “accuracy”. Another optimization algorithm that may be applicable and work well in this case also is “RMSProp.”

The result of the backpropagation processing is to adjust the weight and/or bias values corresponding to one or more connections and/or neurons 514, 515, 525 and 516 in order to reduce loss. Once all the observations of the training data are passed through the neural network 500, an epoch is completed. Another forward propagation is initiated with the adjusted weight and bias values, which is considered as epoch2. The same process of forward and backpropagation is repeated in subsequent epochs. This process of repeating the epochs results in the reduction of loss to a relatively small number (e.g., close to 0), at which point the neural network 500 is considered to be sufficiently trained for prediction. The neural network 500 predicts a cloud provider 507 for a given set of input variables 503.

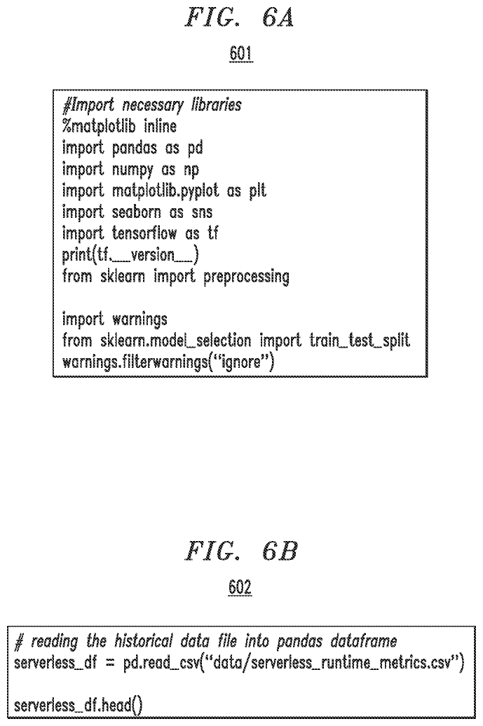

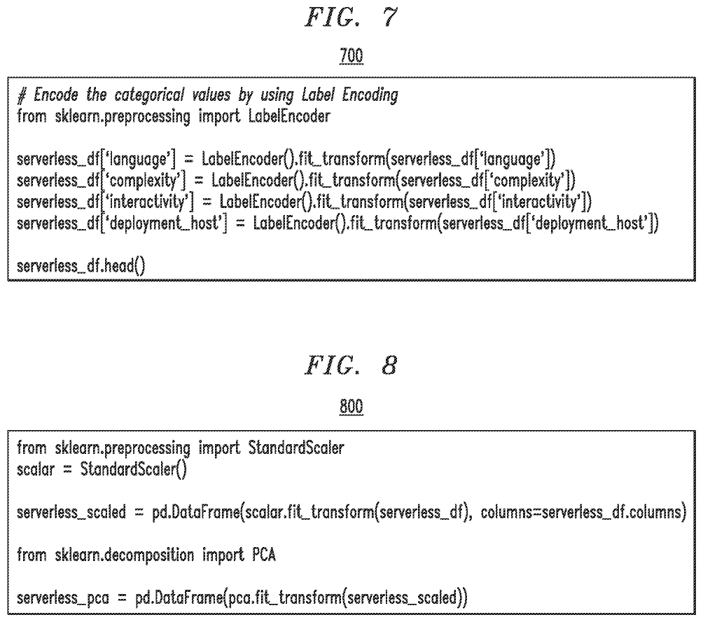

In connection with the operation of the cloud provider prediction engine 140, FIG. 6A depicts example pseudocode 601 for importation of libraries used to implement the cloud provider prediction engine 140. For example, Tensorflow®, Keras, Python, ScikitLearn, Pandas and/or Numpy libraries can be used. Data pre-processing is performed by the serverless function data and metadata repository 160 to identify important features of the historical deployment and/or runtime metrics data and metadata. In more detail, a training dataset is read and a data frame (e.g., Pandas data frame) corresponding to the training dataset is generated. The data frame comprises a plurality of partitioned independent variables (e.g., partitioned in columns) representing the input features (e.g., code size, code language, complexity, interactivity, cost, etc.) and the dependent/target variable column (cloud provider). An initial step is to pre-process the data to address any null or missing values in the partitions (e.g., columns). Null and/or missing values in partitions with numerical data can be replaced by the median value of that partition or other average value (e.g., mean). After generating univariate and/or bivariate plots of the partitions, the importance and influence of each partition is determined. Partitions that have little or no role or influence on the actual prediction (target variables) can be dropped. In other words, one or more of a plurality of partitioned independent variables are identified to be removed from the training dataset based at least in part on whether the one or more of the plurality of partitioned independent variables factor into the prediction of the cloud provider. The identified one or more of the plurality of partitioned independent variables are removed from the training dataset, and the machine learning model is trained with the modified training dataset.

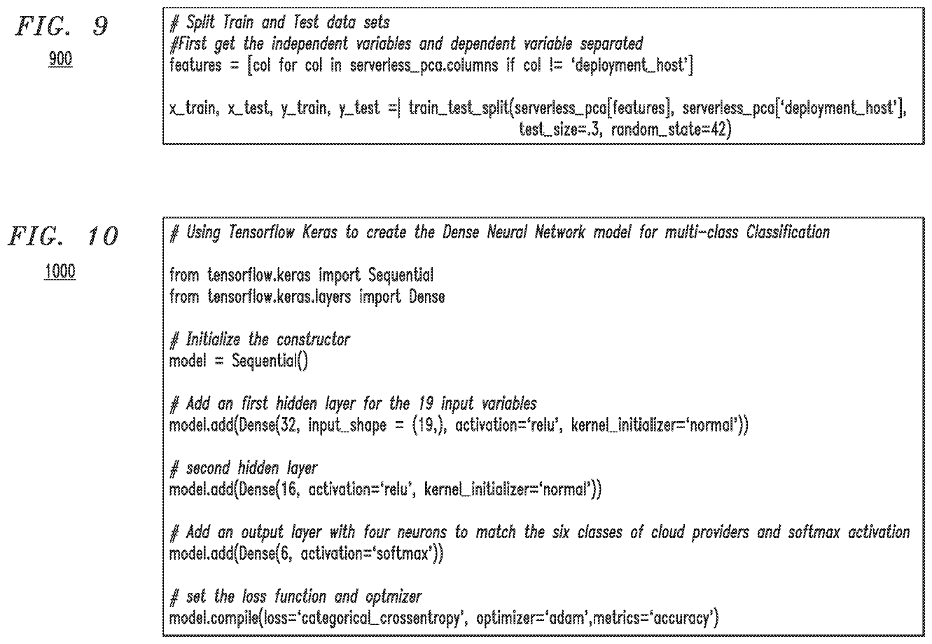

FIG. 6B depicts example pseudocode 602 for loading the historical deployment data and metadata in the form of serverless runtime metrics into a Pandas data frame for building the training data. The data may be in the form of a CSV file. Since machine learning works with vectors (e.g., numbers), categorical and textual attributes like code language, complexity tier, interactivity, cloud provider (“deployment host”), etc. must be encoded before being used as training data. In one or more embodiments, this can be achieved by leveraging a LabelEncoder function of ScikitLearn library as shown in the pseudocode 700 in FIG. 7.

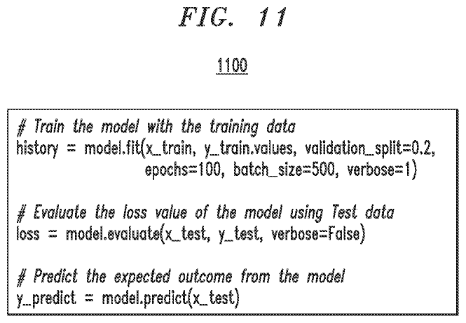

A further step in the process is to reduce the dimensionality of the dataset by applying principal component analysis (PCA). Prior to PCA, the dataset needs to be normalized by applying scaling. This can be achieved by using a StandardScaler function available in ScikitLearn library. After normalization, the data can be passed to a PCA function for dimensionality reduction and made ready for model training. FIG. 8 depicts example pseudocode 800 for normalizing and reducing dimensionality of a dataset.

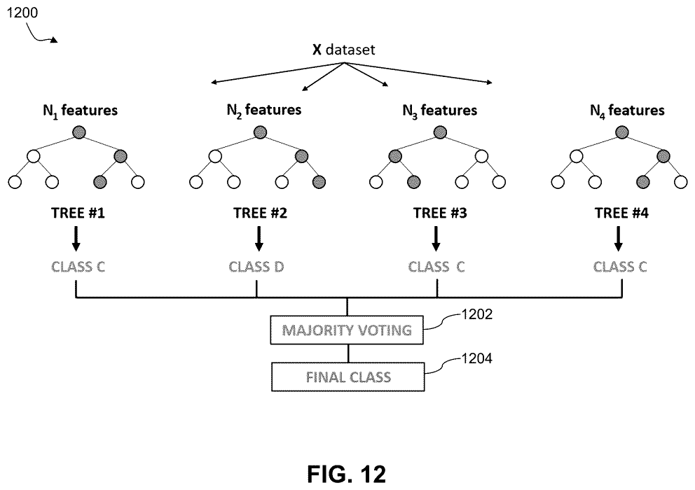

According to illustrative embodiments, the encoded training dataset is split into training and testing datasets, and separate datasets are created for independent variables and dependent variables. FIG. 9 depicts example pseudocode 900 for splitting a dataset into training and testing components and for creating separate datasets for independent (X) and dependent (y) variables. The dataset is split into training and testing datasets using train_test_split function of ScikitLearn library with, for example, a 70%-30% split. Considering this is a multi-class classification use case and a dense neural network will be used as the model, it is important to scale the data before passing the data to the model. Since scaling is already done before PCA, there is no need to scale the data again. At the end of these activities, the data is ready for model training and testing.

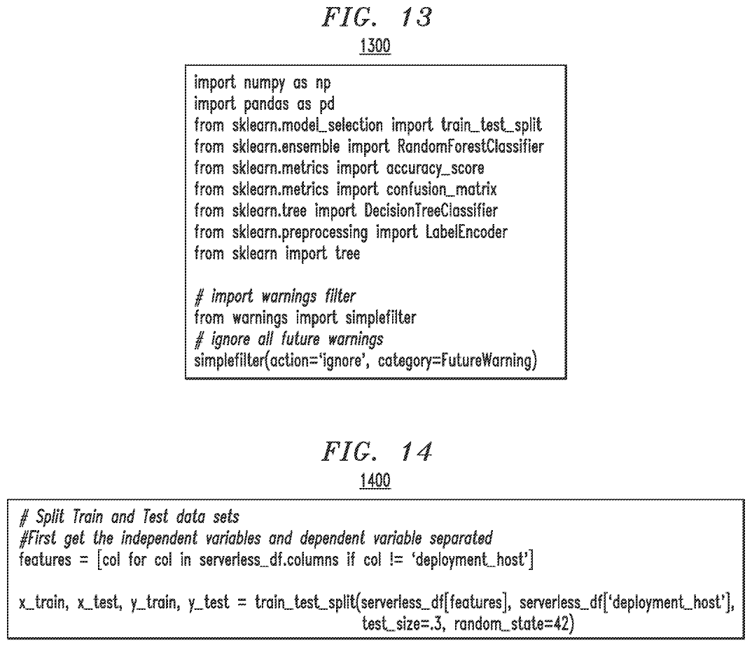

Once the datasets are ready for training and testing, a multi-layer dense neural network (e.g., neural network 500) is created using a Keras library to act as a multi-class classifier. Referring to the pseudocode 1000 in FIG. 10 for building a neural network, using the function Model( ) the functional model is created, and then individual layers of each branch are added by calling an add( ) function of the model and passing an instance of Dense( ) to indicate that the neural network is a dense neural network. As a result, as explained herein above in connection with the neural network 500, the neurons in each layer will connect with all the neurons from preceding and following layers. The Dense( ) function accepts parameters for a number of neurons in a layer, a type of activation function used (e.g., ReLu or Softmax) and if there are any kernel parameters. Multiple hidden layers and the output layer are added by calling the same add( ) function to the model. Once the model is created, loss function, optimizer type and validation metrics are added to the model using a compile( ) function. As noted herein above, “categorical_crossentropy” is used as the loss function, adam is used as the optimizer and “accuracy” is used as a validation metric.

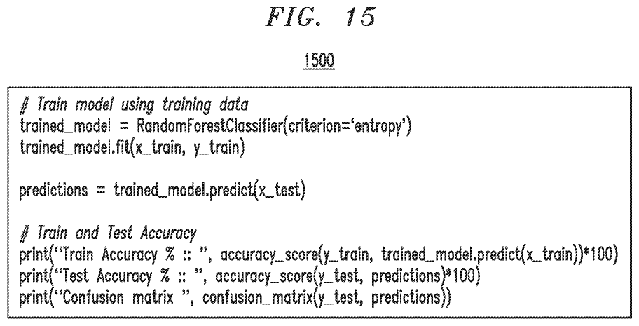

Referring to the pseudocode 1100 for training and computing loss of a neural network model in FIG. 11, neural network model training can be achieved by calling a fit( ) function of the model and passing training data through the neural network for a designated number of epochs. After the model completes a designated number of epochs, the model is trained and ready for validation. A loss/error value can be obtained by calling an evaluate( ) function of the model and passing test data through the neural network. The loss value indicates how well the model is trained. A higher loss value means the model is not trained enough, so hyperparameter tuning is required. The number of epochs can be increased to train the model more. Other hyperparmeter tuning can be done by changing the loss function, optimizer algorithm and/or making changes to the neural network architecture by adding more hidden layers. Once the model is fully trained with a reasonable value of loss (as close to 0 as possible), the model is ready for prediction. Prediction of the model is achieved by calling a predict( ) function of the model and passing the independent variables of test data through the neural network (for comparing training vs test data) or passing the real values through neural network to predict a cloud provider (target variable).

In illustrative embodiments, as an alternative or in addition to the above-described deep learning approach, a shallow learning approach leverages a decision tree-based, ensemble bagging technique with a random forest algorithm as a multi-class classification approach for predicting the class which is the cloud provider for the serverless function. The random forest algorithm is used for prediction and recommendation because of its efficiency and accuracy of processing large volumes of data. The random forest algorithm uses bagging (bootstrap aggregating) to generate predictions; this includes using multiple classifiers (e.g., in parallel) each trained on different data samples and different features. This reduces the variance and the bias that results from using a single classifier. Final classification is achieved by aggregating the predictions that were made by the different classifiers.

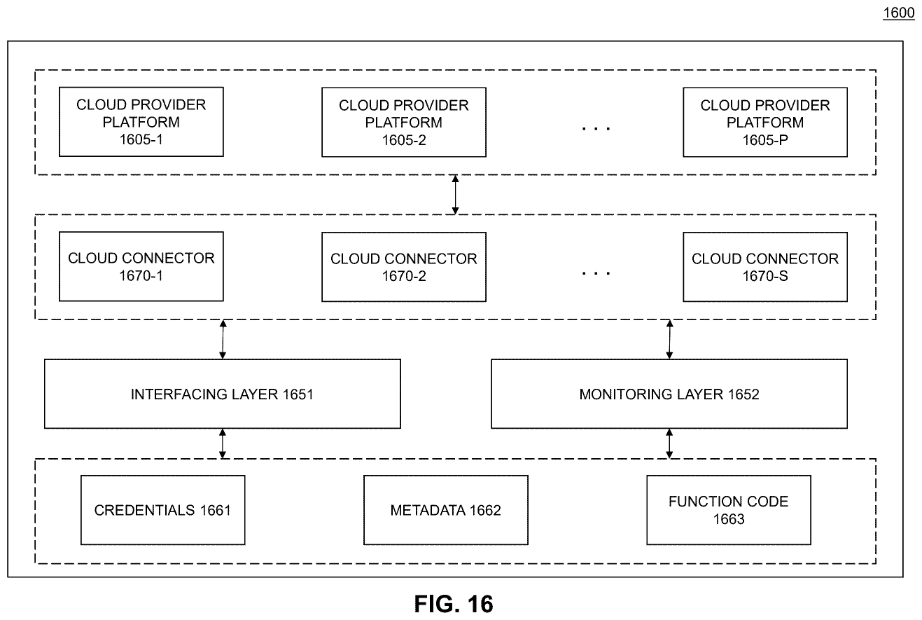

Referring to the random forest classifier diagram 1200 in FIG. 12, the machine learning layer 141 constructs a plurality of decision trees (Tree #1, Tree #2, Tree #3 and Tree #4) using different features and different data samples, which reduces bias and variance as noted above. In the training process, the decision trees Tree #1, Tree #2, Tree #3 and Tree #4 are constructed using the training data, which comprises, for example, historical deployment data and metadata and/or runtime data and metadata. In the testing process, data (“X dataset” in FIG. 12) comprising, for example, code size, code language, complexity tier, interactivity determination, cold start and execution times, memory consumption, cost, etc., is inputted to the multiple decision trees (Tree #1, Tree #2, Tree #3 and Tree #4) to generate a predicted class (e.g., Class C or D) representing a cloud provider. Based on the inputted data, each decision tree (Tree #1, Tree #2, Tree #3 and Tree #4) yields a class corresponding to a cloud provider and the final prediction (final class 1204) is determined by majority voting 1202 (which class received the majority of votes). In illustrative embodiments, a random forest classifier uses multinomial/multi-class classification, meaning the results of the classification would be one of a few types of classes. Each class is a cloud provider, so there are potentially multiple classes and the model predicts one of the classes (cloud providers) with a confidence score. The multiple independent variables comprise the features of the X dataset as explained hereinabove, whereas the target variable (Y value) is the cloud provider class predicted/recommended by the model. Random forest classification is based on the wisdom of a plurality of models. Instead of using just one model (e.g., decision tree) to make a prediction, a random forest technique uses multiple uncorrelated decision trees, which outperforms the methodology when using single tree. The use of multiple decision trees minimizes errors, when compared with using a single decision tree. In this model, even if some trees might yield an incorrect result, the majority of decision trees will produce a correct result. Although four decision trees are shown, the embodiments are not necessarily limited to four decision trees, and more or less decision trees may be used.

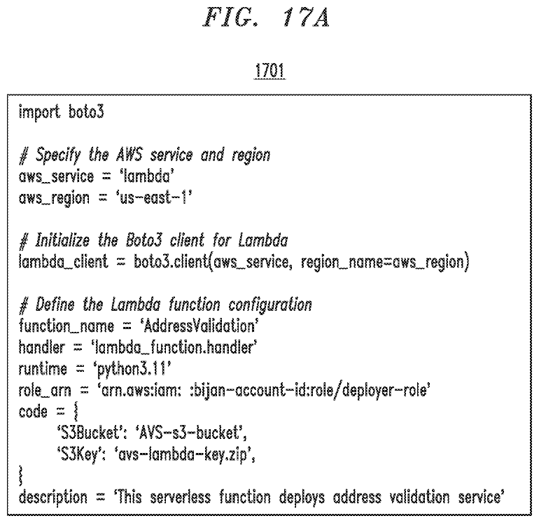

In connection with the operation of the cloud provider prediction engine 140 in a shallow learning approach, FIG. 13 depicts example pseudocode 1300 for importation of libraries used to implement the cloud provider prediction engine 140. For example, Python, ScikitLearn, Pandas and Numpy libraries can be used. Illustrative embodiments implement multi-class classification using a random forest classifier to predict a cloud provider for optimized deployment of a serverless function.

Referring back to the pseudocode 602 in FIG. 6B and to the pseudocode 700 in FIG. 7, like in the deep learning approach, in the shallow learning approach FIG. 6B depicts example pseudocode 602 of historical deployment data and metadata in the form of serverless runtime metrics being loaded into a Pandas data frame for building the training data. The data may be in the form of a CSV file. As shown in the pseudocode 700 in FIG. 7, since machine learning works with vectors (e.g., numbers), categorical and textual attributes like code language, complexity tier, interactivity, cloud provider (“deployment host”), etc. are encoded before being used as training data. This can be achieved by leveraging a LabelEncoder function of ScikitLearn library.

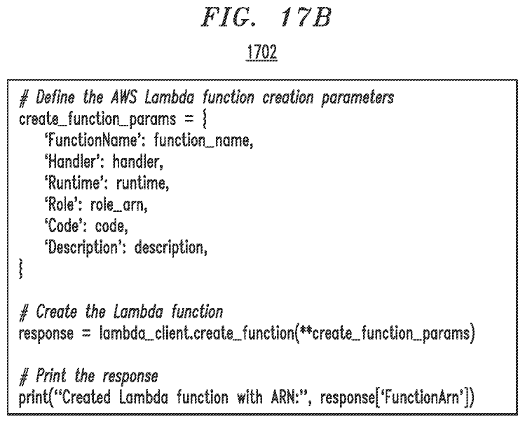

Referring to the pseudocode 1400 in FIG. 14, in connection with the operation of the cloud provider prediction engine 140 in the shallow learning approach, the encoded data is split into training and testing sets using a train_test_split function of an sklearn library. The training set is used for training the machine learning model(s) while the test set is used for testing/validating and computing accuracy score(s) of the model(s). In some embodiments, a training set will contain 70% of the observations, while a testing set will contain 30% of the observations. The function also separates the target variable (y) and the independent variables (X). FIG. 14 depicts example pseudocode 1400 for splitting a dataset into training and testing components and for creating separate datasets for independent (X) and target (y) variables.

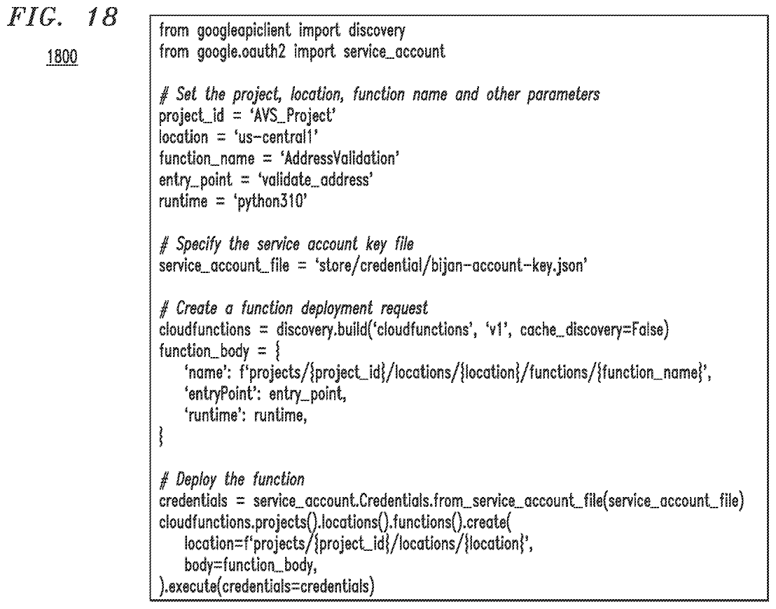

Then, referring to FIG. 15, pseudocode 1500 for training and computing accuracy of a random forest classifier is shown. In some embodiments, a random forest classifier is used to predict a cloud provider for a given function. Once trained, the model evaluates the test data including the independent variables (X_test) to predict a cloud provider. The predictions, accuracy and confusion matrix are printed. Hyperparameter tuning can be done to improve the accuracy of the model.

Referring back to the operational flow 200 in FIG. 2, when users and/or applications 203 request to deploy a serverless function, the serverless function deployment workflow engine 120 sends a call to the cloud deployment state engine to verify whether the function has been previously deployed. If the function was not previously deployed, the serverless function deployment workflow engine 120 sends a call to the cloud provider prediction engine 140 to predict a cloud provider to deploy the serverless function. Following the prediction, the serverless function deployment workflow engine 120 sends code associated with the serverless function and data and metadata corresponding to the predicted cloud provider (e.g., one of cloud provider platforms 105-1, 105-2, 105-3 or 105-4) to the cloud provider interface and monitoring engine 150. The cloud provider interface and monitoring engine 150 generates one or more APIs based at least in part on the code of the function and data and/or metadata corresponding to the predicted cloud provider platform 105. The cloud provider interface and monitoring engine 150 invokes the one or more APIs to communicate the request for cloud deployment of the serverless function to the predicted cloud provider platform 105.

In illustrative embodiments, once deployed, the serverless function deployment workflow engine 120 updates the cloud deployment state engine 130 with a digest of the serverless function and the utilized cloud provider platform 105. Data and metadata corresponding to the code and features of the serverless function and the corresponding cloud provider platform 105 are persisted in the serverless function data and metadata repository 160 for future training of the machine learning models used by the cloud provider prediction engine 140. In addition, runtime metrics corresponding to the deployment of serverless functions from the cloud provider platforms 105 are captured from the cloud provider platforms 105 by the cloud provider interface and monitoring engine 150 on a periodic basis. As explained in more detail herein, such capturing of runtime metrics can be achieved by calling appropriate software development kits (SDKs) and APIs (for example boto3 in AWS). The runtime metrics data and metadata is stored in the serverless function data and metadata repository 160 for future training of the machine learning models used by the cloud provider prediction engine 140.

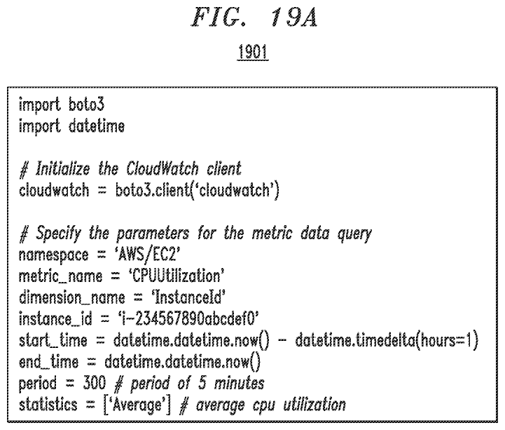

Referring to the operational diagram 1600 in FIG. 16, the interfacing layer 1651, which is the same or similar to the interfacing layer 151 of the cloud provider interface and monitoring engine 150, functions as an abstraction layer for various cloud providers and hides the complexities of interfacing with serverless function deployments from requesters of serverless function deployments. The interfacing layer 1651 interfaces with the cloud provider platforms 1605-1, . . . 1605-P (collectively “cloud provider platforms 1605”) via one or more cloud 1605-2, connectors 1670-1, 1670-2, . . . 1670-S (collectively “cloud connectors 1670”). The cloud provider platforms 1605 may be the same as or similar to the cloud provider platforms 105. As different cloud provider platforms 1605 use different APIs and metadata types, the interfacing layer 1651 creates the appropriate interfaces, data types and calls the necessary APIs of the cloud provider platform 1605 on which a serverless function is to be deployed. While some of the metadata 1662 may be unique to particular cloud provider platforms 1605, other metadata 1662 may be universal to the cloud provider platforms 1605. For example, information like function code 1663, function_name, function description, run_time (e.g python 3.10), deployment region, etc., can be the same across different cloud provider platforms 1605. Some information may be specific to a cloud provider platform 1605, such as, for example, identity credentials (e.g., credentials 1661), storage locations (e.g., S3 bucket), etc.

The monitoring layer 1652, which is the same or similar to the monitoring layer 152 of the cloud provider interface and monitoring engine 150, monitors the existing (e.g., already deployed) functions in a multi-cloud environment. The monitoring layer 1652 connects to the cloud provider platforms 1605 via one or more cloud connectors 1670. The cloud provider interface and monitoring engine 150 creates custom cloud connectors 1670 using the credentials 1661 and APIs for each cloud provider platform 1605 and uses the cloud connectors 1670 for deployment and monitoring. The monitoring layer 1652 captures runtime metrics of the deployed serverless functions, which can be used as further training data for the machine learning models in the cloud provider prediction engine 140.

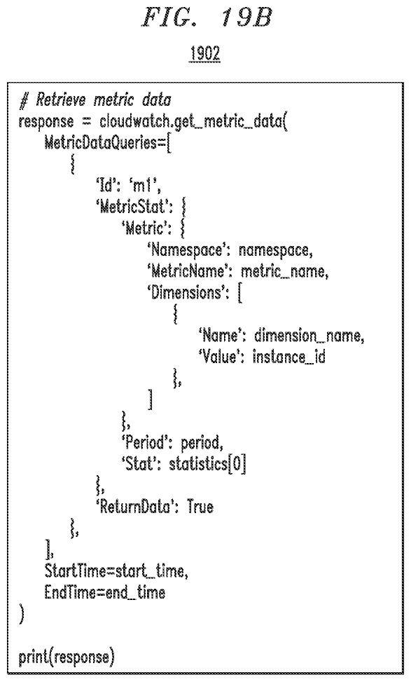

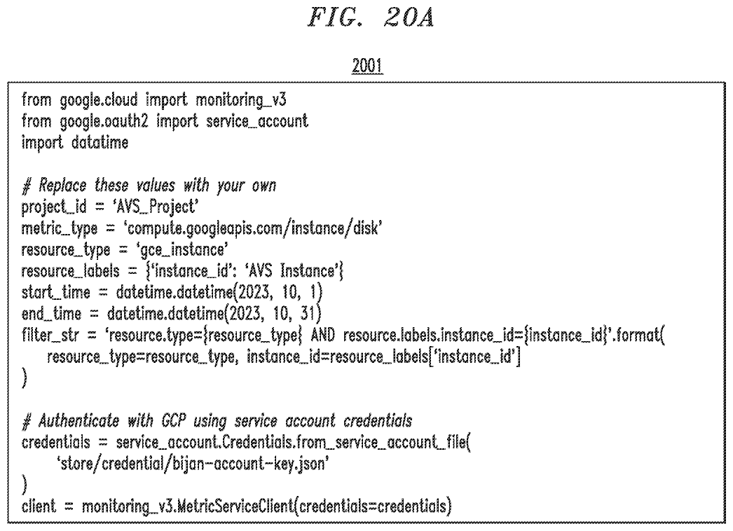

The cloud provider interface and monitoring engine 150 leverages the serverless function code (e.g., function code 1663) and associated metadata (e.g., metadata 1662) to build the payload for the appropriate API of the predicted cloud provider platform 105/1605. Pseudocode 1701 and 1702 for deploying a serverless function using boto3 libraries in AWS® is shown in FIGS. 17A and 17B. Pseudocode 1800 for deploying a serverless function in Google® cloud platform using its API is shown in FIG. 18.

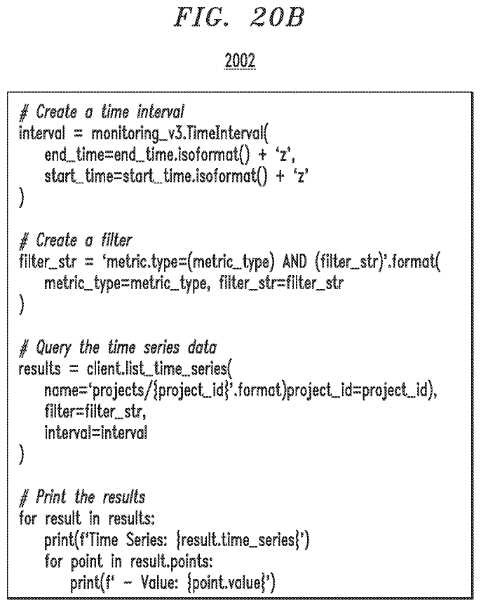

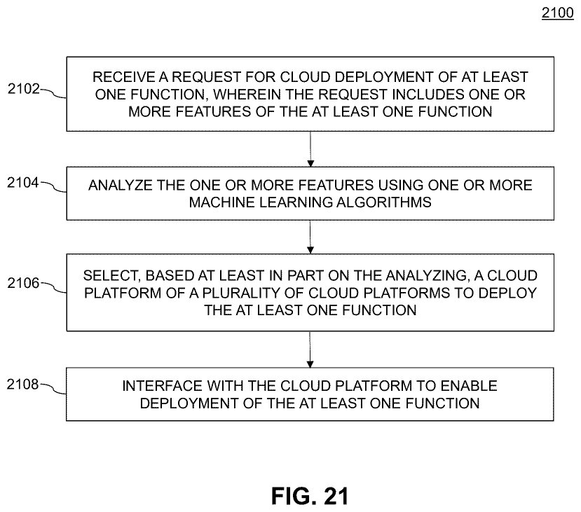

In illustrative embodiments, the metrics of serverless functions can be obtained by the monitoring layer 152/1652 by calling appropriate services in a public cloud. For example, AWS® Lambda® serverless function metrics can be obtained from a CloudWatch® service and the boto3 client API can be used to call the CloudWatch® managed service and return the metrics. FIGS. 19A and 19B depict sample pseudocode 1901 and 1902 that return average CPU utilization and other metrics data from CloudWatch®. FIGS. 20A and 20B depict example pseudocode 2001 and 2002 for retrieving serverless function metrics from a Google® cloud platform.

In some embodiments, the serverless function data and metadata repository 160, storage layer 132 and other data corpuses, repositories or databases referred to herein are implemented using one or more storage systems or devices associated with the cloud deployment platform 110. In some embodiments, one or more of the storage systems utilized to implement the serverless function data and metadata repository 160, storage layer 132 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the cloud deployment platform 110, the serverless function deployment workflow engine 120, cloud deployment state engine 130, cloud provider prediction engine 140, cloud provider interface and monitoring engine 150 and/or serverless function data and metadata repository 160 in other embodiments can be implemented at least in part externally to the cloud deployment platform 110, for example, as stand-alone servers, sets of servers or other types of systems coupled to the network 104. For example, the serverless function deployment workflow engine 120, cloud deployment state engine 130, cloud provider prediction engine 140, cloud provider interface and monitoring engine 150 and/or serverless function data and metadata repository 160 may be provided as cloud services accessible by the cloud deployment platform 110.

The serverless function deployment workflow engine 120, cloud deployment state engine 130, cloud provider prediction engine 140, cloud provider interface and monitoring engine 150 and/or serverless function data and metadata repository 160 in the FIG. 1 embodiment are each assumed to be implemented using at least one processing device. Each such processing device generally comprises at least one processor and an associated memory, and implements one or more functional modules for controlling certain features of the serverless function deployment workflow engine 120, cloud deployment state engine 130, cloud provider prediction engine 140, cloud provider interface and monitoring engine 150 and/or serverless function data and metadata repository 160.

At least portions of the cloud deployment platform 110 and the elements thereof may be implemented at least in part in the form of software that is stored in memory and executed by a processor. The cloud deployment platform 110 and the elements thereof comprise further hardware and software required for running the cloud deployment platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the serverless function deployment workflow engine 120, cloud deployment state engine 130, cloud provider prediction engine 140, cloud provider interface and monitoring engine 150, serverless function data and metadata repository 160 and other elements of the cloud deployment platform 110 in the present embodiment are shown as part of the cloud deployment platform 110, at least a portion of the serverless function deployment workflow engine 120, cloud deployment state engine 130, cloud provider prediction engine 140, cloud provider interface and monitoring engine 150, serverless function data and metadata repository 160 and other elements of the cloud deployment platform 110 in other embodiments may be implemented on one or more other processing platforms that are accessible to the cloud deployment platform 110 over one or more networks. Such elements can each be implemented at least in part within another system element or at least in part utilizing one or more stand-alone elements coupled to the network 104.

It is assumed that the cloud deployment platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the serverless function deployment workflow engine 120, cloud deployment state engine 130, cloud provider prediction engine 140, cloud provider interface and monitoring engine 150, serverless function data and metadata repository 160 and other elements of the cloud deployment platform 110, and the elements thereof can each be implemented in the form of one or more LXCs running on one or more VMs. Other arrangements of one or more processing devices of a processing platform can be used to implement the serverless function deployment workflow engine 120, cloud deployment state engine 130, cloud provider prediction engine 140, cloud provider interface and monitoring engine 150 and serverless function data and metadata repository 160, as well as other elements of the cloud deployment platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the cloud deployment platform 110 to reside in different data centers. Numerous other distributed implementations of the cloud deployment platform 110 are possible.

Accordingly, one or each of the serverless function deployment workflow engine 120, cloud deployment state engine 130, cloud provider prediction engine 140, cloud provider interface and monitoring engine 150, serverless function data and metadata repository 160 and other elements of the cloud deployment platform 110 can each be implemented in a distributed manner so as to comprise a plurality of distributed elements implemented on respective ones of a plurality of compute nodes of the cloud deployment platform 110.

It is to be appreciated that these and other features of illustrative embodiments are presented by way of example only, and should not be construed as limiting in any way. Accordingly, different numbers, types and arrangements of system elements such as the serverless function deployment workflow engine 120, cloud deployment state engine 130, cloud provider prediction engine 140, cloud provider interface and monitoring engine 150, serverless function data and metadata repository 160 and other elements of the cloud deployment platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the cloud deployment platform can be offered to cloud infrastructure customers or other users as part of FaaS, CaaS and/or PaaS offerings.

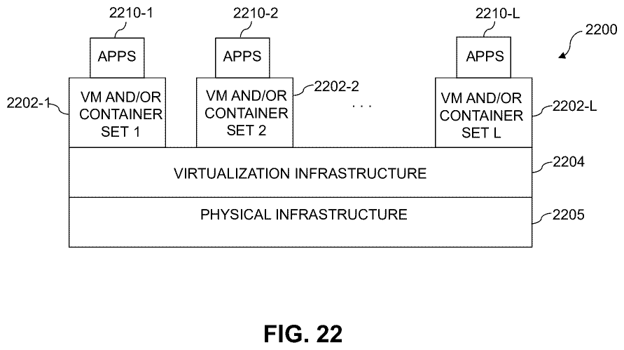

The operation of the information processing system 100 will now be described in further detail with reference to the flow diagram of FIG. 21. With reference to FIG. 21, a process 2100 for cloud deployment as shown includes steps 2102 through 2108, and is suitable for use in the system 100 but is more generally applicable to other types of information processing systems comprising a cloud deployment platform configured for selecting and interfacing with cloud providers to deploy serverless functions.

In step 2102, a request for cloud deployment of at least one function is received. The request includes one or more features of the at least one function. At least a portion of the one or more features comprises metadata, and the one or more features identify, for example, a size of code for the at least one function, a language of the code for the at least one function, a complexity tier of the at least one function, an interactivity determination of the at least one function, a cold start time of the at least one function, an execution time of the at least one function, a memory consumption of the at least one function and/or a cost of the at least one function.

In step 2104, the one or more features are analyzed using one or more machine learning algorithms. In illustrative embodiments, the one or more machine learning algorithms are trained with historical feature data of a plurality of functions. The historical feature data specifies respective ones of the plurality of functions associated with at least one of: (i) a code size; (ii) a code language; (iii) a complexity tier; (iv) an interactivity determination; (v) a cold start time; (vi) an execution time; (vii) a memory consumption; and (viii) a cost.

In some embodiments, the one or more machine learning algorithms comprise a neural network including at least two hidden layers utilizing a ReLu activation function. The analyzing may comprise inputting the one or more features to the neural network, which predicts the cloud platform to deploy the at least one function. The neural network can comprise a plurality of nodes connected with each other, respective ones of the connections comprising a weight factor and respective ones of the plurality of nodes comprising a bias factor.

In step 2106, based at least in part on the analyzing, a cloud platform of a plurality of cloud platforms is selected to deploy the at least one function. In some embodiments, the one or more machine learning algorithms comprise a plurality of decision trees, and the plurality of decision trees are respectively trained with different portions of the historical feature data. Each of the plurality of decision trees yields one cloud platform of the plurality of cloud platforms to deploy the at least one function, and the selection of the cloud platform to deploy the at least one function corresponds to the result produced by a majority of the plurality of decision trees.

Step 2108 comprises interfacing with the cloud platform to enable deployment of the at least one function. In illustrative embodiments, the interfacing comprises generating one or more APIs based at least in part on code of the at least one function and metadata corresponding to the cloud platform, and invoking the one or more APIs to communicate the request for cloud deployment of the at least one function to the cloud platform.

One or more runtime metrics corresponding to the deployment of the at least one function may be collected from the cloud platform, wherein the one or more runtime metrics are used for training the one or more machine learning algorithms.

In illustrative embodiments, a deployment history of the at least one function is verified prior to the analyzing and the selecting. The verifying may comprise determining whether the at least one function was previously deployed on the cloud platform, and if the at least one function was previously deployed on the cloud platform, determining whether code for the at least one function is unchanged from the previous deployment.

A unique identifier for the deployment of the at least one function may be generated. Generating the unique identifier can comprise using a hash function to generate a hash digest of one or more files corresponding to the deployment of the at least one function.

It is to be appreciated that the FIG. 21 process and other features and functionality described above can be adapted for use with other types of information systems configured to execute cloud deployment services in a cloud deployment platform or other type of platform.

The particular processing operations and other system functionality described in conjunction with the flow diagram of FIG. 21 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 21 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a cloud deployment platform as disclosed herein can provide a number of significant advantages relative to conventional arrangements. For example, the cloud deployment platform uses machine learning to predict and automatically select cloud providers for use in connection with deploying different serverless functions. The embodiments advantageously leverage sophisticated machine learning classification techniques that are trained using multi-dimensional, historical feature data and runtime metrics of a plurality of functions to predict cloud providers that are most appropriate for given serverless functions.

Unlike conventional approaches, illustrative embodiments provide technical solutions which offer a modular and pluggable cloud deployment framework for multiple functions requiring heterogenous cloud providers. Advantageously, the framework enables prediction of cloud providers for different functions and interfacing with the different cloud providers that require different configurations and/or metadata. As an additional advantage, the embodiments provide techniques to monitor and capture runtime metrics of current serverless function deployments, and use the captured runtime metrics for additional training of machine learning models being used to predict the cloud providers for the respective functions.

Existing cloud deployment approaches undesirably rely on containerization of function deployments, which are not cloud provider agnostic. In addition, current cloud deployment techniques for serverless functions fail to take into account the lack of standardization between cloud providers and are not capable of dynamically provisioning multiple cloud providers for different functions as requirements evolve. To address these technical problems, the embodiments provide technical solutions which formulate programmatically and with a high degree of accuracy the capability to use specialized machine learning algorithms to intelligently predict cloud providers that will yield optimal results for serverless deployment of particular functions. By using deep learning, shallow learning and/or a combination of deep and shallow learning techniques, machine learning algorithms of illustrative embodiments advantageously analyze multiple combinations of function features to efficiently and accurately predict an optimal cloud platform for respective serverless functions.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the cloud deployment platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a cloud deployment platform in illustrative embodiments. These and other cloud-based systems in illustrative embodiments can include object stores.

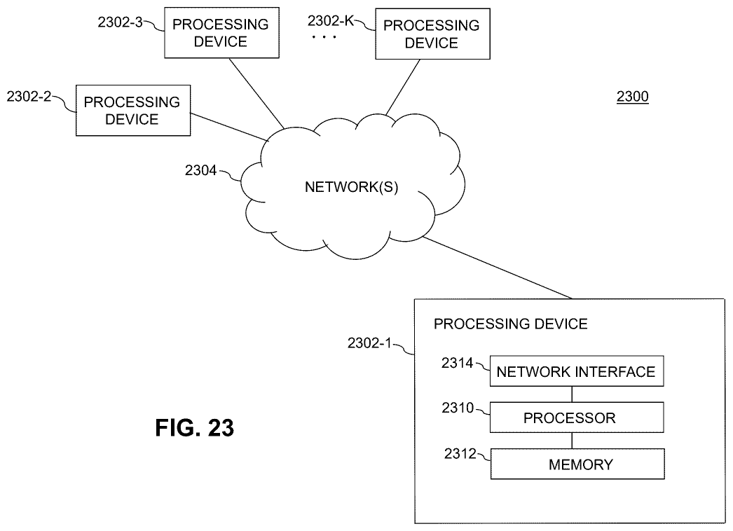

Illustrative embodiments of processing platforms will now be described in greater detail with reference to FIGS. 22 and 23. Although described in the context of system 100, these platforms may also be used to implement at least portions of other information processing systems in other embodiments.

FIG. 22 shows an example processing platform comprising cloud infrastructure 2200. The cloud infrastructure 2200 comprises a combination of physical and virtual processing resources that may be utilized to implement at least a portion of the information processing system 100. The cloud infrastructure 2200 comprises multiple virtual machines (VMs) and/or container sets 2202-1, 2202-2, . . . 2202-L implemented using virtualization infrastructure 2204. The virtualization infrastructure 2204 runs on physical infrastructure 2205, and illustratively comprises one or more hypervisors and/or operating system level virtualization infrastructure. The operating system level virtualization infrastructure illustratively comprises kernel control groups of a Linux operating system or other type of operating system.

The cloud infrastructure 2200 further comprises sets of applications 2210-1, 2210-2, . . . 2210-L running on respective ones of the VMs/container sets 2202-1, 2202-2, . . . 2202-L under the control of the virtualization infrastructure 2204. The VMs/container sets 2202 may comprise respective VMs, respective sets of one or more containers, or respective sets of one or more containers running in VMs.

In some implementations of the FIG. 22 embodiment, the VMs/container sets 2202 comprise respective VMs implemented using virtualization infrastructure 2204 that comprises at least one hypervisor. A hypervisor platform may be used to implement a hypervisor within the virtualization infrastructure 2204, where the hypervisor platform has an associated virtual infrastructure management system. The underlying physical machines may comprise one or more distributed processing platforms that include one or more storage systems.

In other implementations of the FIG. 22 embodiment, the VMs/container sets 2202 comprise respective containers implemented using virtualization infrastructure 2204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 2200 shown in FIG. 22 may represent at least a portion of one processing platform. Another example of such a processing platform is processing platform 2300 shown in FIG. 23.

The processing platform 2300 in this embodiment comprises a portion of system 100 and includes a plurality of processing devices, denoted 2302-1, 2302-2, 2302-3, . . . 2302-K, which communicate with one another over a network 2304.

The network 2304 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2302-1 in the processing platform 2300 comprises a processor 2310 coupled to a memory 2312. The processor 2310 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 2312 may comprise random access memory (RAM), read-only memory (ROM), flash memory or other types of memory, in any combination. The memory 2312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2302-1 is network interface circuitry 2314, which is used to interface the processing device with the network 2304 and other system components, and may comprise conventional transceivers.

The other processing devices 2302 of the processing platform 2300 are assumed to be configured in a manner similar to that shown for processing device 2302-1 in the figure.

Again, the particular processing platform 2300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the cloud deployment platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and cloud deployment platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request for cloud deployment of at least one function, wherein the request includes one or more features of the at least one function;
analyzing the one or more features using one or more machine learning algorithms;
selecting, based at least in part on the analyzing, a cloud platform of a plurality of cloud platforms to deploy the at least one function; and
interfacing with the cloud platform to enable deployment of the at least one function;
wherein the steps of the method are executed by a processing device operatively coupled to a memory.

2. The method of claim 1 wherein at least a portion of the one or more features comprises metadata.

3. The method of claim 1 wherein the one or more features identify at least one of a size of code for the at least one function, a language of the code for the at least one function, a complexity tier of the at least one function, an interactivity determination of the at least one function, a cold start time of the at least one function, an execution time of the at least one function, a memory consumption of the at least one function and a cost of the at least one function.

4. The method of claim 1 further comprising verifying a deployment history of the at least one function.

5. The method of claim 4 wherein the verifying comprises:
determining whether the at least one function was previously deployed on the cloud platform; and
if the at least one function was previously deployed on the cloud platform, determining whether code for the at least one function is unchanged from the previous deployment.

6. The method of claim 1 further comprising generating a unique identifier for the deployment of the at least one function, wherein generating the unique identifier comprises using a hash function to generate a hash digest of one or more files corresponding to the deployment of the at least one function.

7. The method of claim 1 wherein:
the one or more machine learning algorithms comprise a neural network including at least two hidden layers utilizing a rectified linear unit activation function;
the analyzing comprises inputting the one or more features to the neural network which predicts the cloud platform to deploy the at least one function; and
the neural network comprises a plurality of nodes connected with each other, respective ones of the connections comprising a weight factor and respective ones of the plurality of nodes comprising a bias factor.

8. The method of claim 1 further comprising training the one or more machine learning algorithms with historical feature data of a plurality of functions, wherein the historical feature data specifies respective ones of the plurality of functions associated with at least one of: (i) a code size; (ii) a code language; (iii) a complexity tier; (iv) an interactivity determination; (v) a cold start time; (vi) an execution time; (vii) a memory consumption; and (viii) a cost.

9. The method of claim 8 wherein the one or more machine learning algorithms comprise a plurality of decision trees, and the plurality of decision trees are respectively trained with different portions of the historical feature data.

10. The method of claim 9 wherein:
each of the plurality of decision trees yields one cloud platform of the plurality of cloud platforms to deploy the at least one function; and
the selection of the cloud platform to deploy the at least one function corresponds to a result produced by a majority of the plurality of decision trees.

11. The method of claim 1 wherein the interfacing comprises:
generating one or more application programming interfaces based at least in part on code of the at least one function and metadata corresponding to the cloud platform; and
invoking the one or more application programming interfaces to communicate the request for cloud deployment of the at least one function to the cloud platform.

12. The method of claim 1 further comprising collecting one or more runtime metrics corresponding to the deployment of the at least one function from the cloud platform.

13. The method of claim 12 wherein the one or more runtime metrics are used for training the one or more machine learning algorithms.

14. An apparatus comprising:
a processing device operatively coupled to a memory and configured:
to receive a request for cloud deployment of at least one function, wherein the request includes one or more features of the at least one function;
to analyze the one or more features using one or more machine learning algorithms;
to select, based at least in part on the analyzing, a cloud platform of a plurality of cloud platforms to deploy the at least one function; and
to interface with the cloud platform to enable deployment of the at least one function.

15. The apparatus of claim 14 wherein the processing device is further configured to generate a unique identifier for the deployment of the at least one function, wherein generating the unique identifier comprises using a hash function to generate a hash digest of one or more files corresponding to the deployment of the at least one function.

16. The apparatus of claim 14 wherein:
the processing device is further configured to train the one or more machine learning algorithms with historical feature data of a plurality of functions; and
the historical feature data specifies respective ones of the plurality of functions associated with at least one of: (i) a code size; (ii) a code language; (iii) a complexity tier; (iv) an interactivity determination; (v) a cold start time; (vi) an execution time; (vii) a memory consumption; and (viii) a cost.

17. The apparatus of claim 14 wherein, in interfacing with the cloud platform to enable deployment of the at least one function, the processing device is configured:
generate one or more application programming interfaces based at least in part on code of the at least one function and metadata corresponding to the cloud platform; and
invoke the one or more application programming interfaces to communicate the request for cloud deployment of the at least one function to the cloud platform.

18. An article of manufacture comprising a non-transitory processor-readable storage medium having stored therein program code of one or more software programs, wherein the program code when executed by at least one processing device causes said at least one processing device to perform the steps of:
receiving a request for cloud deployment of at least one function, wherein the request includes one or more features of the at least one function;
analyzing the one or more features using one or more machine learning algorithms;
selecting, based at least in part on the analyzing, a cloud platform of a plurality of cloud platforms to deploy the at least one function; and
interfacing with the cloud platform to enable deployment of the at least one function.

19. The article of manufacture of claim 18 wherein the program code further causes said at least one processing device to perform the step of generating a unique identifier for the deployment of the at least one function, wherein generating the unique identifier comprises using a hash function to generate a hash digest of one or more files corresponding to the deployment of the at least one function.

20. The article of manufacture of claim 18 wherein, in interfacing with the cloud platform to enable deployment of the at least one function, the program code causes said at least one processing device to perform the steps of:
generating one or more application programming interfaces based at least in part on code of the at least one function and metadata corresponding to the cloud platform; and
invoking the one or more application programming interfaces to communicate the request for cloud deployment of the at least one function to the cloud platform.
